(19) United States
(12) Patent Application Publication
(10) Pub. No.: US 2022/0364341 A1
(43) Pub. Date: Nov. 17, 2022

(54) KITCHEN SHOWER

(71) Applicant: XIAMEN SUITEC SANITARY WARES & FITTINGS CO LTD, Xiamen (CN)

(72) Inventor: Jianquan Zhang, Xiamen (CN)

(21) Appl. No.: 17/347,603

(22) Filed: Jun. 15, 2021

(30) Foreign Application Priority Data
May 17, 2021 (CN) 202121045944.2

(51) Int. Cl. E03C 1/04

(52) U.S. Cl. CPC E03C 1/0405; E03C 2001/0415

(57) ABSTRACT

A kitchen shower includes a water outlet mechanism, a switching mechanism and a brush mechanism. The water outlet mechanism is provided with a shower water outlet, a sheet water outlet and a bubble water outlet. The switching mechanism includes a main body, a first switching assembly, a second switching assembly and a third switching component. The first switching assembly is used to switch whether the kitchen shower is out of water, the second switching assembly is used to switch the kitchen shower out of sheet water, and the second switching assembly is used to switch the kitchen shower out of shower water or bubble water. The brush mechanism is detachable and installed on the water outlet mechanism. The brush mechanism can make the kitchen shower clean at the same time of water outlet, so that the cleaning effect is higher.

### CROSS-REFERENCE OF RELATED APPLICATIONS

The present application claims the benefit of Chinese Patent Application No. 202121045944.2, entitled “Kitchen Shower,” filed on May 17, 2021, in the China National Intellectual Property Administration, the entire content of which is incorporated herein in its entirety.

### TECHNICAL FIELD

The present disclosure relates to the technical field of sanitary equipment, in particular to a kitchen shower.

### BACKGROUND

Kitchen shower is a kind of shower commonly used in kitchen sink, which often has a variety of ways to water, in order to deal with the different situations, such as washing dishes, chopsticks, vegetables, fruits, and cleaning sink.

In the prior art, this kind of kitchen shower has a variety of water outlet modes, which brings great difficulty to the switching structure of water outlet mode. In order to include the corresponding switching components in the limited volume, the switching structure of rotating water head is often used, but this kind of switching structure is not easy to operate with one hand. However, in the process of using the kitchen shower, the user often holds the dishes that need to be cleaned in one hand and operate the shower in the other hand, resulting in the user can not easily switch the water outlet mode. In addition, in the prior art, in order to realize a variety of water outlet ways, this kind of kitchen shower often has a complex structure, which is not convenient for the miniaturization of the product, but also greatly increases the cost of the product. In view of this, the present disclosure is provided after studying the prior art.

### SUMMARY

The technical problem to be solved by the disclosure lies in overcoming at least one of the shortcomings in the prior art and providing a kitchen shower, which includes:

A water outlet mechanism, which is provided with a sprinkling water outlet, a sheet water outlet and a bubble water outlet. A switching mechanism, which includes a main body provided with a first valve groove, a second valve groove and a third valve groove; the switching mechanism further includes a first switching assembly arranged in the first valve groove, a second switching assembly arranged in the second valve groove, and a third switching component arranged in the third valve groove; the first valve groove is provided with a first chamber, the second valve groove is provided with a second chamber and a third chamber, and the third valve groove is provided with a fourth chamber and a fifth chamber; the main body is further provided with a first channel communicating the first chamber and the second valve groove, a second channel communicating the second chamber and the sheet water outlet, and a third channel communicating the third chamber and the third valve groove. The sheet water outlet is communicated with the second chamber, the bubble water outlet is communicated with the fourth chamber, and the shower water outlet is communicated with the fifth chamber; the first switching assembly is configured to switch an communication between the first chamber and an external water source; the second switching assembly is configured to switch that the first channel is communicated with the second chamber or the third chamber; the third switching component is configured to switch that the third channel is communicated with the fourth chamber or the fifth chamber.

In some embodiments, the kitchen shower further includes a brush mechanism, the brush mechanism includes a brush head and bristles, the brush head is detachably arranged on the water outlet mechanism, and the bristles are arranged on the brush head.

In some embodiments, an end surface of the water outlet mechanism is provided with a mounting boss, and a side wall of the mounting boss is provided with a clamping groove; the brush head is provided with a mounting groove matching with the mounting boss, and a side wall of the mounting groove is provided with a clamping protrusion matching with the clamping groove.

In some embodiments, the mounting boss is a circular boss; the clamping groove includes a first groove portion and a second groove portion, the first groove portion is communicated with an end surface of the mounting boss, and the second groove portion is communicated and approximately perpendicular to the first groove portion; the clamping groove is provided with a first limiting bulge, the first limiting bulge is located at a position where the first groove portion is communicated with the second groove portion; the clamping protrusion is provided with a second limiting bulge matched with the first limiting bulge.

The brush head is arranged in the mounting groove through the mounting boss, the clamping protrusion is arranged ion the water outlet mechanism in the way that the clamping protrusion is arranged on the first groove portion; the brush head is able to rotate relative to the water outlet mechanism to force the second limiting bulge to pass the first limiting bulge, so that the clamping protrusion is switched from the first groove portion to the second groove portion.

In some embodiments, the sheet water outlet and the bubble water outlet are respectively arranged on the mounting boss, and the sprinkling water outlet is arranged around the mounting boss.

In some embodiments, the brush head is provided with a shower hole communicated with the bubble water outlet.

In some embodiments, the first channel, the second channel and the third channel are respectively arranged in grooves of the main body; the switching mechanism includes a side cover configured on the main body to restrict the communication between the first channel, the second channel and the third channel and the outside.

In some embodiments, the first switching assembly includes a first switching shaft, a first sealing member, a first elastic member and a first button; the first sealing member is sheathed on the first switching shaft, and the first button is configured to drive the first switching shaft downward, the first elastic member is configured to drive the first switching shaft to reset; the first sealing member drives the first sealing member to move up and down, and so as to switch whether the first chamber is communicated with the outside or not.

The second switching assembly includes a second switching shaft, a second sealing member, a second elastic member and a second button, the second sealing member is sheathed on the second switching shaft, the second button is configured to drive the second switching shaft to move downward, and the second elastic member is configured to drive the second switching shaft to reset; the second sealing member drives the first sealing member to move up and down, so as to switch the first channel to communicate with the second chamber or the third chamber.

The third switching component includes a third switching shaft, a third sealing member, a third elastic member and a third button, the third sealing member is sheathed on the third switching shaft, the third button is configured to drive the third switching shaft to move downward, and the third elastic member is configured to drive the third switching shaft to reset; the third switching shaft drives the third sealing member to move up and down, so as to switch the third channel to communicate with the fourth chamber or the fifth chamber.

In some embodiments, the first button and the second button are buttons respectively configured on the first switching shaft and the second switching shaft; the third button is hinged on the main body, and the third button is configured to drive the third switching shaft to move up and down with a hinged point as a rotation center.

In some embodiments, the kitchen shower further includes a shell mechanism, the shell mechanism includes a shell covering the main body; the first button, the second button and the third button are respectively exposed to the shell.

By adopting the above technical solution, the present disclosure can obtain the following technical effects:

1. The main body of the switching mechanism of the kitchen shower of the utility model is provided with the first valve groove, the second valve groove, the third valve groove, the first channel, the second channel and the third channel, which can greatly simplify the waterway, reduce waterway accessories, and then make the structure of the kitchen shower more simple, reducing costs.

2. By setting the first switching assembly, the second switching assembly and the third switching component, the kitchen shower of the utility model can complete the switching of water outlet with only one hand.

3. By setting a brush mechanism, the kitchen shower of the utility model can facilitate the cleaning of vegetable pots and the like. In addition, the brush mechanism is detachable and configured on the water outlet mechanism, which can realize the replacement of the brush mechanism.

### BRIEF DESCRIPTION OF THE DRAWINGS

In order to more clearly illustrate the technical solution of the embodiment of the present disclosure, the following drawings will be briefly introduced. It should be understood that the following drawings only show some embodiments of the present disclosure, which should not be regarded as the limitation of the scope. For ordinary skilled person in the art, without paying creative labor, other related drawings may also be obtained from these drawings.

FIG. 1 is a schematic diagram of the first shaft side structure of a kitchen shower according to an embodiment of the present disclosure.

FIG. 2 is a partial exploded diagram of a kitchen shower according to an embodiment of the present disclosure.

FIG. 3 is a sectional structure diagram of a kitchen shower according to an embodiment of the present disclosure.

FIG. 4 is a schematic diagram of the second shaft side structure of the kitchen shower according to an embodiment of the present disclosure (the shell 310 is removed).

FIG. 5 is an exploded diagram of a brush mechanism and a water outlet mechanism according to an embodiment of the present disclosure.

FIG. 6 is a structural diagram of the brush mechanism according to an embodiment of the present disclosure.

### MARKS IN THE DRAWINGS

100—switching mechanism; 110—the first switching assembly; 120—the second switching assembly; 130—the third switching component; 140—main body; 150—side cover; 111—the first button; 112—the first switching shaft; 113—the first sealing member; 114—the first elastic member; 121—the second button; 122—the second switching shaft; 123—the second elastic member; 124—the second sealing member; 131—the third button; 132—the third switching shaft; 133—the third elastic member; 134—the third sealing member; 141—the first valve groove; 142—the second valve groove; 143—the third valve groove; 141A—the first chamber; 142A—the second chamber; 142B—the third chamber; 143A—fourth chamber; 143B—the fifth chamber; 144—the first channel; 145—the second channel; 146—the third channel;
200—brush mechanism; 210—brush head; 220—bristles; 211—mounting groove; 212—clamping protrusion; 213—the second limiting bulge; 214—shower hole;
300—shell mechanism; 310 shell;
400—water outlet mechanism; 410—sprinkling water outlet; 420—sheet water outlet; 430—bubble water outlet; 440—mounting boss; 441—clamping groove; 442—the first limiting bulge; 441A—the first groove portion; 441B—the second groove portion.

### DETAILED DESCRIPTION OF THE EMBODIMENTS

The present disclosure is further described in detail in combination with the drawings and the specific embodiments.

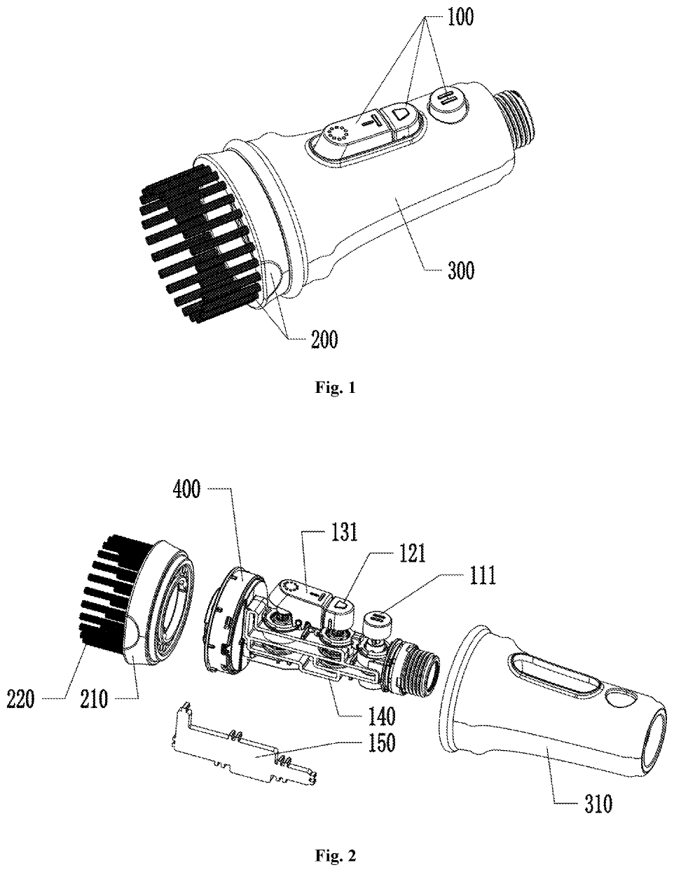

As shown in FIG. 1 and FIG. 2, this embodiment provides a kitchen shower, which includes a water outlet mechanism 400, a switching mechanism 100, a brush mechanism 200 and a shell mechanism 300. The switching mechanism 100 is used to switch the water outlet channel, so that the water outlet mechanism 400 can realize different water outlet, and the brush mechanism 200 is detachably installed on the water outlet mechanism 400, so that the user can do cleaning when the kitchen shower is used. The details are as follows:

As shown in FIG. 2 and FIG. 5, in this embodiment, the water outlet mechanism 400 is provided with a sprinkling water outlet 410, a sheet water outlet 420 and a bubble water outlet 430. The sprinkling water outlet 410 is used to spray sprinkling water, the sheet water outlet 420 is used to produce sheet water, and the bubble water outlet 430 is used to produce bubble water. The sprinkling water outlet 410 is arranged around the sheet water outlet 420 and the bubble water outlet 430.

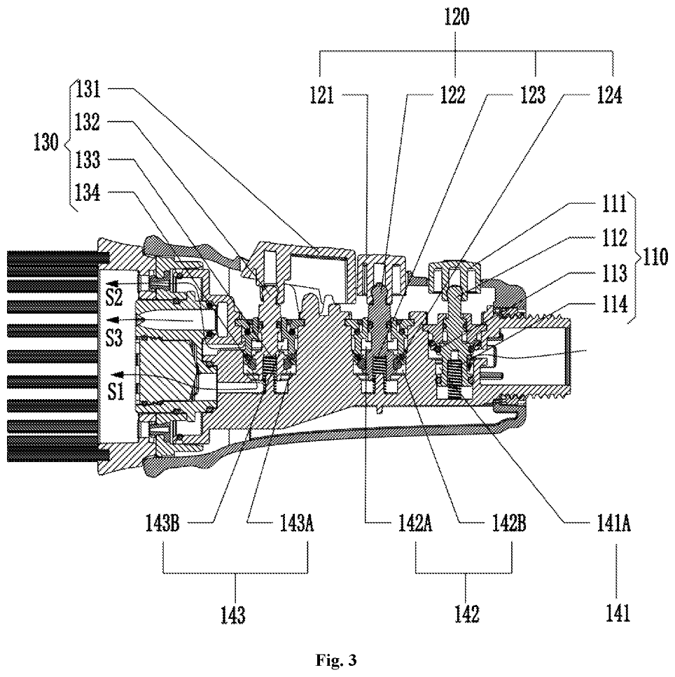

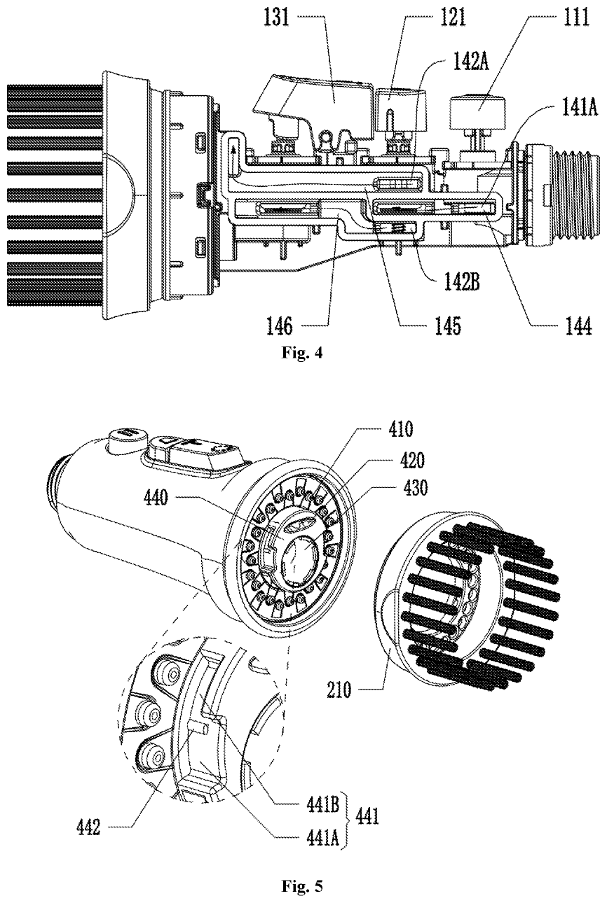

As shown in FIG. 3 and FIG. 4, in this embodiment, the switching mechanism 100 includes a main body 140, a side cover 150, a first switching assembly 110, a second switching assembly 120 and a third switching component 130. The main body 140 is provided with a first valve groove 141, a second valve groove 142 and a third valve groove 143. In addition, the main body 140 is also provided with a first channel 144, a second channel 145 and a third channel 146. The first switching assembly 110 is arranged in the first valve groove 141, the second switching assembly 120 is arranged in the second valve groove 142, and the third switching component 130 is arranged in the third valve groove 143.

It should be noted that the first valve groove 141 is provided with a first chamber 141A, the second valve groove 142 is provided with a second chamber 142A and a third chamber 142B, and the third valve groove 143 is provided with a fourth chamber 143A and a fifth chamber 143B. The first channel 144 is communicated with the first chamber 141A and the second valve groove 142, the second channel 145 is communicated with the second chamber 142A and the sheet water outlet 420, and the third channel 146 is communicated with the third chamber 142B and the third valve groove 143. In operation, the first switching assembly 110 can realize whether the first chamber 141A is communicated with the external water source. Through the second switching assembly 120, the first channel 144 can be communicated to the second chamber 142A or the third chamber 142B. Through the third switching component 130, the third channel 146 can be communicated to the fourth chamber 143A or the fifth chamber 143B. In this embodiment, the sheet water outlet 420 is communicated with the second chamber 142A, the bubble water outlet 430 is communicated with the fourth chamber 143A, and the sprinkling water outlet 410 is communicated with the fifth chamber 143B. Therefore, the first switching assembly 110 can realize whether the kitchen shower is watering, the second switching assembly 120 can realize the water outlet of sheet water, and the third switching component 130 can realize the switching of sprinkling water and bubble water.

Specifically, as shown in FIG. 3, the first switching assembly 110 includes a first switching shaft 112, a first sealing member 113, a first elastic member 114 and a first button 111. Wherein, the first sealing member 113 is a sealing ring sheathed on the first switching shaft 112, the first button 111 is installed on the upper end of the first switching shaft 112 and passes through the shell mechanism 300, and the first elastic member 114 is a spring supported under the first switching shaft 112. The first button 111 can drive the first sealing member 113 to move downward and compress the first elastic member 114, so that the external water can not flow into the first chamber 141A. When the first switching shaft 112 is driven upward by the first elastic member 114, the external water can flow into the first chamber 141A. Therefore, through the first switching assembly 110, the first chamber 141A can be switched to be communicated or not to be communicated with the outside, so as to realize the control of whether the water from the kitchen shower or not.

As shown in FIG. 3 and FIG. 4, the second switching assembly 120 includes a second switching shaft 122, a second sealing member 124, a second elastic member 123 and a second button 121. Wherein, the second sealing member 124 is a sealing ring sheathed on the second switching shaft 122, the second button 121 is installed on the upper end of the second switching shaft 122 and passes through the shell mechanism 300, and the second elastic member 123 is a spring supported under the second switching shaft 122. The second button 121 can drive the second sealing member 124 to move downward and compress the second elastic member 123, so that the first channel 144 is communicated with the second chamber 142A. When the second switching shaft 122 is driven upward for reset by the second elastic member 123, the first channel 144 is communicated with the third chamber 142B. Therefore, the first channel 144 can be switched to communicate with the second chamber 142A or the third chamber 142B through the second switching assembly 120. In addition, since the sheet water outlet 420 is communicated with the second chamber 142A, the second switching assembly 120 can realize whether the sheet water is discharged from the kitchen shower. In FIG. 3, the trajectory S3 is a local waterway of sheet water.

As shown in FIG. 3 and FIG. 4, the third switching assembly 130 includes a third switching shaft 132, a third sealing member 134, a third elastic member 133 and a third button 131. The third sealing element 134 is a sealing ring sheathed on the third switching shaft 132, the third button 131 is hinged on the main body 140, the third button 131 can drive the third switching shaft 132 to move up and down with the hinge as the rotation center, and the third elastic element 133 is a spring supported under the third switching shaft 132. The third button 131 can drive the third sealing ring to move up and down with the third switching shaft 132, so as to switch the third channel 146 to communicate with the fourth chamber 143A or the fifth chamber 143B. In addition, the bubble water outlet 430 and the sprinkling water outlet 410 are located in the fourth chamber 143A and the fifth chamber 143B respectively. Therefore, the third switching assembly 130 can realize the switching between the bubble water and the sprinkling water. In FIG. 3, trajectories S1 and S2 are the local waterways of bubble water and sprinkling water respectively.

In addition, the kitchen shower of the present embodiment, the first button 111 and the second button 121 can respectively press to realize the switching of the first switching assembly 110 and the second switching assembly 120, and the third button 131 can be switched by front and rear hinge pressing. Therefore, the user can realize the switching operation of the first button 111, the second button 121 and the third button 131 by single hand operation during the use, which has good practicability.

As shown in FIG. 2 and FIG. 4, in this embodiment, the first channel 144, the second channel 145 and the third channel 146 are the grooves respectively arranged on the main body 140. In addition, the switching mechanism 100 also includes a side cover 150 for covering the openings above the grooves. Specifically, in this case, the side cover 150 is sealed in the upper opening of these channels by means of welding. Through the split arrangement of the main body 140 and the side cover 150, it is not only convenient to set the first channel 144, the second channel 145 and the third channel 146, so that the structure of the main body 140 can be more simplified. At the same time, this split structure can greatly reduce the difficulty of the production of the main body 140 by forming and other processes.

As shown in FIG. 1, FIG. 2 and FIG. 3, in this embodiment, the shell mechanism 300 includes a shell 310 covering the main body 140, which can play the role of wrapping and decorating the water outlet mechanism 400 and the switching mechanism 100.

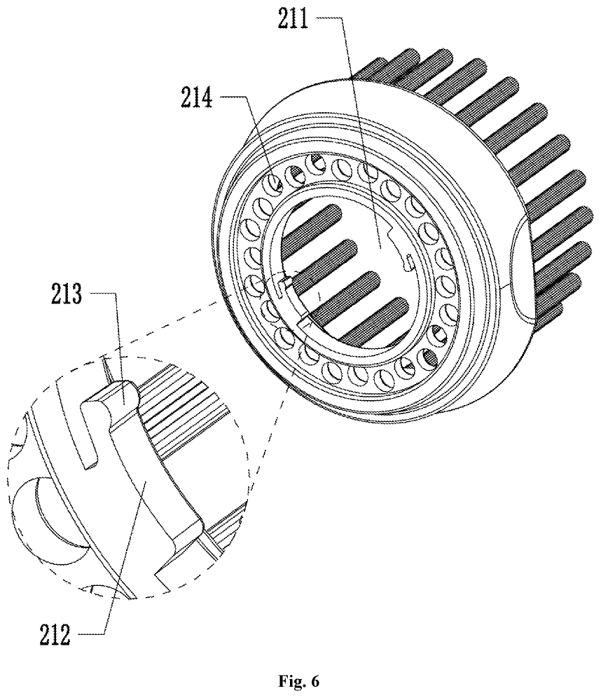

As shown in FIG. 1, FIG. 2, FIG. 5 and FIG. 6, in this embodiment, the brush mechanism 200 includes a brush head 210 and a bristles 220, the brush head 210 is detachably arranged on the water outlet mechanism 400, and the bristles 220 is fixed on the brush head 210. Specifically, as shown in FIG. 5 and FIG. 6, the end surface of the water outlet mechanism 400 is provided with a circular mounting boss 440, the side wall of the mounting boss 440 is provided with a pair of clamping grooves 441, and the connecting line of the pair of clamping grooves 441 passes through the center of the circle of the mounting boss 440. The brush head 210 is provided with a mounting groove 211 matched with the mounting boss 440, and the side wall of the mounting groove 211 is provided with a clamping protrusion 212 matched with the clamping groove 441. The mounting boss 440 can also facilitate the user to mount the brush head 210 on the mounting boss 440.

Specifically, as shown in FIG. 5 and FIG. 6, the clamping groove 441 includes a first groove portion 441A and a second groove portion 441B, the first groove portion 441A and the end edge of the mounting boss 440 are communicated, and the second groove portion 441B is communicated and is approximately perpendicular to the first groove portion 441A. In addition, the clamping groove 441 is provided with a first limiting bulge 442. The first limiting bulge 442 is approximately located in the position where the first groove portion 441A and the second groove portion 441B are communicated. Accordingly, the clamping protrusion 212 is provided with a second limiting bulge 213 matched with the first limiting bulge 442. In specific operation, firstly, let the mounting boss 440 align with the mounting groove 211, and at the same time, the clamping protrusion 212 is aligned with the first groove portion 441A, and the brush head 210 is configured on the water outlet mechanism 400. Next, the brush head 210 and the water outlet mechanism 400 are rotated relative to make the clamping protrusion 212 switch from the first groove portion 441A to the second groove portion 441B. Of course, in this process, the second limiting bulge 213 will be forced to pass the first limiting bulge 442, so as to ensure that the first limiting bulge 442 will limit the second limiting bulge 213 to pass during normal use, so that the brush head 210 will not fall during the use. It is necessary to note that when the brush head 210 needs to be replaced, the brush head 210 can be rotated in reverse, so that the clamping protrusion 212 can be switched from the second groove portion 441B to the first groove portion 441A, so as to remove the brush mechanism 200.

In addition, as shown in FIG. 5, in this embodiment, the sheet water outlet 420 and the bubble water outlet 430 are respectively arranged on the mounting boss 440, and the sprinkling water outlet 410 is arranged around the mounting boss 440. The brush head 210 is also provided with a shower hole 214 communicated with the bubble water outlet 430. When the brush mechanism 200 is installed on the water outlet mechanism 400, the sheet water and bubble water can be ejected through the mounting groove 211, and the sprinkling water can be ejected through the shower hole 214.

Through the above solution of the embodiment, the switching mechanism 100 of the kitchen shower in this case is not only simple in structure, but also the user can switch the first switching assembly 110, the second switching assembly 120 and the third switching component 130 with only one hand, which has good practicability and solves the pain point of switching the kitchen shower with two hands in the prior art. In addition, the kitchen shower of the present disclosure can also be installed with a brush head 210, so that the user can quickly clean the kitchen sink and other utensils.

The above description is only the preferred embodiment of the present disclosure and is not used to limit the present disclosure. For those skilled in the art, the present disclosure can have various changes and modifications. Any modification, equivalent replacement, improvement, etc. made within the spirit and principle of the present disclosure shall be included in the protection scope of the present disclosure.

What is claimed is:

1. A kitchen shower, comprising:
a water outlet mechanism (400) is provided with a sprinkling water outlet (410), a sheet water outlet (420) and a bubble water outlet (430);
a switching mechanism (100) comprises a main body (140) provided with a first valve groove (141), a second valve groove (142) and a third valve groove (143); the switching mechanism (100) further comprises a first switching assembly (110) arranged in the first valve groove (141), a second switching assembly (120) arranged in the second valve groove (142), and a third switching component (130) arranged in the third valve groove (143); the first valve groove (141) is provided with a first chamber (141A), the second valve groove (142) is provided with a second chamber (142A) and a third chamber (142B), and the third valve groove (143) is provided with a fourth chamber (143A) and a fifth chamber (143B); the main body (140) is further provided with a first channel (144) communicating the first chamber (141A) and the second valve groove (142), a second channel (145) communicating the second chamber (142A) and the sheet water outlet (420), and a third channel (146) communicating the third chamber (142B) and the third valve groove (143);
the sheet water outlet (420) is communicated with the second chamber (142A), the bubble water outlet (430) is communicated with the fourth chamber (143A), and the shower water outlet (410) is communicated with the fifth chamber (143B); the first switching assembly (110) is configured to switch an communication between the first chamber (141A) and an external water source; the second switching assembly (120) is configured to switch that the first channel (144) is communicated with the second chamber (142A) or the third chamber (142B); the third switching component (130) is configured to switch that the third channel (146) is communicated with the fourth chamber (143A) or the fifth chamber (143B).

2. The kitchen shower according to claim 1, wherein the kitchen shower further comprises a brush mechanism (200), the brush mechanism (200) comprises a brush head (210) and bristles (220), the brush head (210) is detachably arranged on the water outlet mechanism (400), and the bristles (220) are arranged on the brush head (210).

3. The kitchen shower according to claim 2, wherein an end surface of the water outlet mechanism (400) is provided with a mounting boss (440), and a side wall of the mounting boss (440) is provided with a clamping groove (441); the brush head (210) is provided with a mounting groove (211) matching with the mounting boss (440), and a side wall of the mounting groove (211) is provided with a clamping protrusion (212) matching with the clamping groove (441).

4. The kitchen shower according to claim 3, wherein the mounting boss (440) is a circular boss; the clamping groove (441) comprises a first groove portion (441A) and a second groove portion (441B), the first groove portion (441A) is communicated with an end surface of the mounting boss (440), and the second groove portion (441B) is communicated and approximately perpendicular to the first groove portion (441A); the clamping groove (441) is provided with a first limiting bulge (442), the first limiting bulge (442) is located at a position where the first groove portion (441A) is communicated with the second groove portion (441B); the clamping protrusion (212) is provided with a second limiting bulge (213) matched with the first limiting bulge (442);
the brush head (210) is arranged in the mounting groove (211) through the mounting boss (440), the clamping protrusion (212) is arranged ion the water outlet mechanism (400) in the way that the clamping protrusion (212) is arranged on the first groove portion (441A); the brush head (210) is able to rotate relative to the water outlet mechanism (400) to force the second limiting bulge (213) to pass the first limiting bulge (442), so that the clamping protrusion (212) is switched from the first groove portion (441A) to the second groove portion (441B).

5. The kitchen shower according to claim 3, wherein the sheet water outlet (420) and the bubble water outlet (430) are respectively arranged on the mounting boss (440), and the sprinkling water outlet (410) is arranged around the mounting boss (440).

6. The kitchen shower according to claim 2, wherein the brush head (210) is provided with a shower hole (214) communicated with the bubble water outlet (430).

7. The kitchen shower according to claim 1, wherein the first channel (144), the second channel (145) and the third channel (146) are respectively arranged in grooves of the main body (140); the switching mechanism (100) comprises a side cover (150) configured on the main body (140) to restrict the communication between the first channel (144), the second channel (145) and the third channel (146) and the outside.

8. The kitchen shower according to claim 1, wherein the first switching assembly (110) comprises a first switching shaft (112), a first sealing member (113), a first elastic member (114) and a first button (111); the first sealing member (113) is sheathed on the first switching shaft (112), and the first button (111) is configured to drive the first switching shaft (112) downward, the first elastic member (114) is configured to drive the first switching shaft (112) to reset; the first sealing member (113) drives the first sealing member (113) to move up and down, and so as to switch whether the first chamber (141A) is communicated with the outside or not;
the second switching assembly (120) comprises a second switching shaft (122), a second sealing member (124), a second elastic member (123) and a second button (121), the second sealing member (124) is sheathed on the second switching shaft (122), the second button (121) is configured to drive the second switching shaft (122) to move downward, and the second elastic member (123) is configured to drive the second switching shaft (122) to reset; the second sealing member (124) drives the first sealing member (113) to move up and down, so as to switch the first channel (144) to communicate with the second chamber (142A) or the third chamber (142B);
the third switching component (130) comprises a third switching shaft (132), a third sealing member (134), a third elastic member (133) and a third button (131), the third sealing member (134) is sheathed on the third switching shaft (132), the third button (131) is configured to drive the third switching shaft (132) to move downward, and the third elastic member (133) is configured to drive the third switching shaft (132) to reset; the third switching shaft (132) drives the third sealing member (134) to move up and down, so as to switch the third channel (146) to communicate with the fourth chamber (143A) or the fifth chamber (143B).

9. The kitchen shower according to claim 8, wherein the first button (111) and the second button (121) are buttons respectively configured on the first switching shaft (112) and the second switching shaft (122); the third button (131) is hinged on the main body (140), and the third button (131) is configured to drive the third switching shaft (132) to move up and down with a hinged point as a rotation center.

10. The kitchen shower according to claim 8, wherein the kitchen shower further comprises a shell mechanism (300), the shell mechanism (300) comprises a shell (310) covering the main body (140); the first button (111), the second button (121) and the third button (131) are respectively exposed to the shell (310).
